(19) United States
(12) Patent Application Publication
(10) Pub. No.: US 2026/0156148 A1
(43) Pub. Date: Jun. 4, 2026

(54) AUTOMATED DETECTION OF WEBSITE IMPERSONATION AND PHISHING ATTEMPTS USING MACHINE LEARNING FOR FEATURE EXTRACTION AND SIMILARITY SEARCH

(71) Applicant: Fortinet, Inc., Sunnyvale, CA (US)

(72) Inventor: Anil Uday Aphale, Maharashtra (IN)

(73) Assignee: Fortinet, Inc., Sunnyvale, CA (US)

(21) Appl. No.: 18/968,748

(22) Filed: Dec. 4, 2024

(51) Int. Cl. H04L 9/40

(52) U.S. Cl. CPC H04L 63/1475

(57) ABSTRACT

A URL is detected that is potentially malicious, and is compared against one or more known legitimate URLs by calculating a similarity score between the detected URL and the known legitimate domain with respect to similarity features. The similarity score comprises a combination of a visual similarity score, a text similarity score and a Document Object Model (DOM) structure similarity score, and the similarity threshold represents a tolerance of variations from minor changes between the detected URL versus the one or more legitimate domains. Responsive to detecting a malicious URL based on the similarity score of the detected URL exceeding the similarity threshold, a security action can be taken against the detected URL as a phishing attempt according to a network security policy.

### FIELD OF THE INVENTION

The invention relates generally to computer networks, and more specifically, to detect phishing attempts using machine learning of similarity features for web page comparisons.

### BACKGROUND

The sophistication and frequency of impersonation and phishing attacks have significantly escalated, posing severe threats to individuals and organizations alike. These cyberattacks are not just limited to stealing personal information; they can also infiltrate organizational systems, steal sensitive business data, and disrupt critical services. Traditional phishing detection methods, which typically rely on static rules and signatures, have become increasingly inadequate against these evolving threats. Static rules can easily be bypassed by sophisticated attackers who frequently change tactics, making these defenses outdated and ineffective.

Such conventional systems struggle to accurately detect modern phishing attempts, often resulting in high false-positive rates and missed detections. The high false-positive rate means that legitimate activities are frequently flagged as threats, causing unnecessary alarms and overwhelming security teams. On the other hand, false negatives, where actual threats go unnoticed, leave systems and data vulnerable. Moreover, as phishing techniques continue to evolve rapidly, these methods fail to scale effectively and cannot adapt quickly enough to keep up with the dynamic nature of cyber threats, leaving organizations vulnerable to large-scale, complex attacks.

Current detection approaches often require extensive manual intervention, such as reviewing alerts and analyzing suspicious activity, resulting in inefficiencies and delays in responding to real-time threats. This reactive approach cannot match the speed and volume of today's cyber-attacks. The growing scale and complexity of phishing attacks necessitate an advanced, automated, and adaptive solution that can accurately identify phishing attempts with minimal human involvement. Such a solution must be capable of real-time analysis to provide immediate responses, scalable to handle large volumes of data generated by modern enterprises, and flexible enough to integrate seamlessly with existing cybersecurity infrastructure while also adapting to emerging phishing techniques and attack patterns.

Therefore, what is needed is a robust technique for reducing false positives in phishing detection by detecting phishing attempts using machine learning of similarity features extracted from web pages for comparisons. By leveraging machine learning and artificial intelligence, these new approaches should automatically detect and respond to threats, reducing the need for manual review and improving overall security posture.

### SUMMARY

To meet the above-described needs, methods, computer program products, and systems for detecting phishing attempts using machine learning of similarity features for web page comparisons.

In one embodiment, a legitimate page database of known legitimate URLs is generated with similarity features. The similarity features can include visual vector embeddings, text embeddings and DOM embeddings extracted from URLs.

In another embodiment, a URL is detected that is potentially malicious, and comparing the detected URL against one or more known legitimate domains by calculating a similarity score between the detected URL and the known legitimate domain with respect to similarity features, against a similarity threshold. The similarity score comprises a combination of a visual similarity score, a text similarity score and a Document Object Model (DOM) structure similarity score, and the similarity threshold represents a tolerance of variations from minor changes between the detected URL versus the one or more legitimate domains. A DOM structure comprises a dynamic representation of the detected URL.

Responsive to detecting a malicious URL based on the similarity score of the detected URL exceeding the similarity threshold, a security action can be taken against the detected URL as a phishing attempt according to a network security policy.

Advantageously, network and network device performance are improved with better network security.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 is a high-level block diagram illustrating aspects of a system for detecting phishing attempts using machine learning of extracted similarity features for web page comparisons, according to some embodiments.

FIG. 2 is a more detailed block diagram illustrating a phishing server of the system of FIG. 1, according to an embodiment.

FIG. 3 is a more detailed block diagram illustrating similarity score algorithms, according to an embodiment.

FIG. 4 is a high-level flow diagram of a method for detect phishing attempts using machine learning of similarity features for web page comparisons, according to an embodiment.

FIG. 5 is a more detailed flow diagrams of a step of using the trained machine language model for real-time URL monitoring, from the method of FIG. 4, according to an embodiment.

FIG. 6 is a block diagram illustrating an example computing device for the system of FIG. 1, according to an embodiment.

### DETAILED DESCRIPTION

Methods, computer program products, and systems for detecting phishing attempts using machine learning of similarity features for web page comparisons. The following disclosure is limited only for the purpose of conciseness, as one of ordinary skill in the art will recognize additional embodiments given the ones described herein.

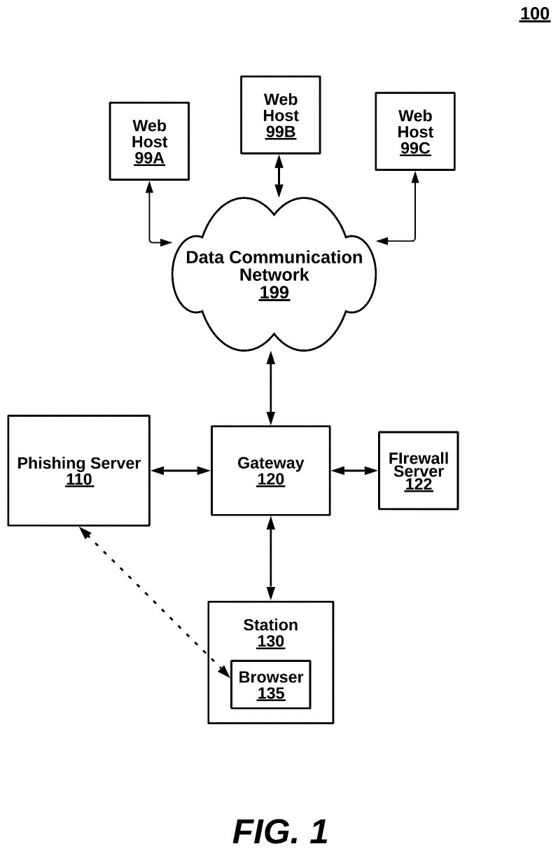

### I. Systems for Phishing Detection With Machine Learning (FIGS. 1-3)

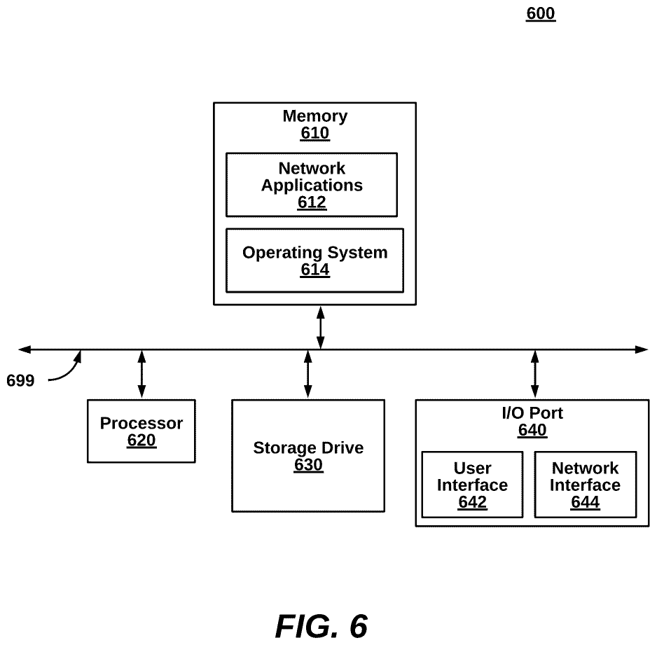

FIG. 1 is a high-level block diagram illustrating a system 100 for detecting phishing attempts using machine learning of similarity features for web page comparisons, according to an embodiment. System 100 includes phishing server 110, gateway device 120 and station 130, running browser app 135 on a local enterprise network. Various web hosts 99A-C are available to the enterprise network over the data communication network 199. Other embodiments of system 100 can include additional components that are not shown in FIG. 1, such as additional servers and gateways, along with Wi-Fi controllers, access points, routers and switches. The components of system 100 can be implemented in hardware, software, or a combination of both. An example implementation of processor-based hardware components is shown in FIG. 6.

In one embodiment, components of system 100 are coupled in communication over a private (or enterprise) network connected to the data communication network 199 which can be a public network, such as the Internet. In another embodiment, system 100 is an isolated, private network, or alternatively, a set of geographically dispersed LANs. The components can be connected to the data communication system via hard wire (e.g., phishing server 110, gateway 120, and station 130). The components can also be connected via wireless networking (e.g., station 130). The data communication network can be composed of any combination of hybrid networks, such as an SD-WAN, an SDN (Software Defined Network), WAN, a LAN, a WLAN, a Wi-Fi network, a cellular network (e.g., 3G, 4G, 5G or 6G), or a hybrid of different types of networks. Various data protocols can dictate format for the data packets. For example, Wi-Fi data packets can be formatted according to IEEE 802.11, IEEE 802,11r, 802.11be, Wi-Fi 6, Wi-Fi 6E, Wi-Fi 7 and the like. Components can use IPv4 or Ipv6 address spaces.

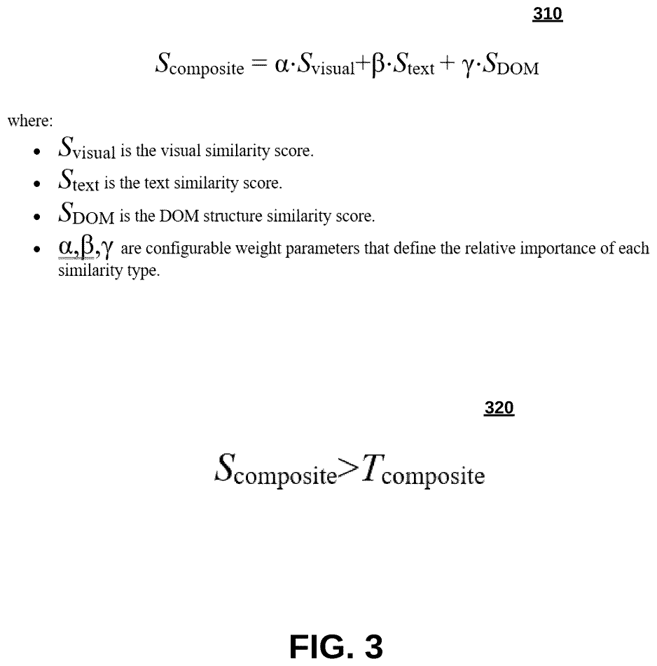

In one embodiment the phishing server 110 leverages machine language to extract web page features and to compare a suspect web page against a known legitimate web page or against a known illegitimate web page. Ultimately, if the composite similarity score 310 exceeds a predefined threshold 320, a suspect URL is flagged as a phishing attempt, as shown in FIG. 3. Some embodiments reinforce the phishing server 110 with online third-party services, for updates, collaborative databases and other offloading of processes. The phishing server 110 can be located on an enterprise network or remotely over the Internet. Functions of the phishing server 110, in some embodiments, is distributed across more than one network device.

The gateway device 120 conducts sessions with the phishing server 110 to identify phishing, in some embodiments. However, detection techniques can also be implemented in access points and stations, as discussed below. In one embodiment, the phishing server 110 is integrated within the gateway device 130 as a software application executing on a local processer within an operating system of the gateway device 120. For training, the gateway device 120 collects web pages confirmed as legitimate and web pages confirmed as illegitimate for a baseline. Machine learning of visual, textual and DOM structure elements of these web pages provides a standard for comparing suspect web pages. A security policy can have rules determine how much a suspect page can deviate from the baseline, before triggering a security action against the suspect page.

The browser 135 on station 130 can also conduct sessions with the phishing server 110 to identify phishing. There can be one or many browser instances for isolation of suspect URLs. The browser 135 can use virtual machines for further partitioning and sandboxing of potentially malicious processes. In one case, a standard browser such as Chrome or Explorer is updated with an app download, a browser extension, or an operating system update, to add phishing detection. Besides the browser 135, other applications that receive URLs can also implement the techniques discussed herein. For example, a firewall for the operating system of station 130 is configurable for phishing detection. Other software applications, such as streaming applications may also utilize phishing detection. For example, a YouTube app can show phishing URLs to users within video streams.

Station 130 can be a processor-driven device running an operating system that hosts the browser 135. In turn, the browser can have its own independent operating system, and virtual machines for further partitioning. Alternatively, the browser operating system is the station operating system, such as a Chromebook device. station 130 can run multiple different browsers or multiple browser instances, at the same time. Additionally, station 130 can run other streaming services apps, online banking apps, text messaging apps, and other components that request online URL content, making them susceptible to phishing.

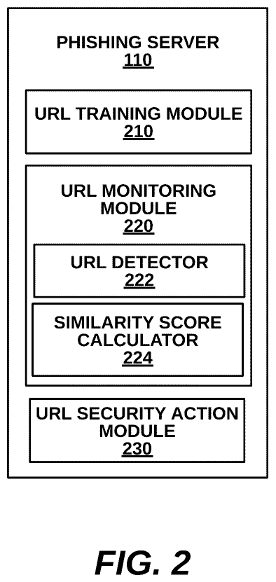

FIG. 2 is a more detailed view of phishing server 110 of FIG. 1, according to an embodiment. The phishing server 110 further includes a URL training module 210, a URL monitoring module 220, a URL security module 230 and a data file interface 240.

The URL training module 210 can generate a legitimate page database of known legitimate domains with similarity features. The similarity features include visual vector embeddings, text embeddings and DOM embeddings, and are extracted from web pages using various automated algorithms.

The URL monitoring module 220 can detect a URL that is potentially malicious with a URL detection module 222, and compare the detected URL against one or more known legitimate domains by calculating a similarity score between the detected URL and the known legitimate domain with respect to similarity features with a similarity score module 224, against a similarity threshold with a similarity threshold module 226.

In an embodiment, the similarity score comprises a combination of a visual similarity score, a text similarity score and a DOM structure similarity score, and the similarity threshold represents a tolerance of variations from minor changes between the detected URL versus the one or more legitimate domains. A DOM structure comprises a dynamic representation of the detected URL. Example algorithms for calculating the various similarity scores and comparisons are shown in FIG. 3.

The URL security module 230, responsive to detecting a malicious URL based on the similarity score of the detected URL exceeding the similarity threshold, can take a security action against the detected URL as a phishing attempt according to a network security policy. The security action can be defined by rules from a general network security policy, a phishing policy, or other variation. For example, a notification can be sent to an administrator along with automated actions, such as quarantining, blocking and restricting.

There are numerous variations to those that are listed herein, that would be apparent to one of ordinary skill in the art, given the disclosure herein.

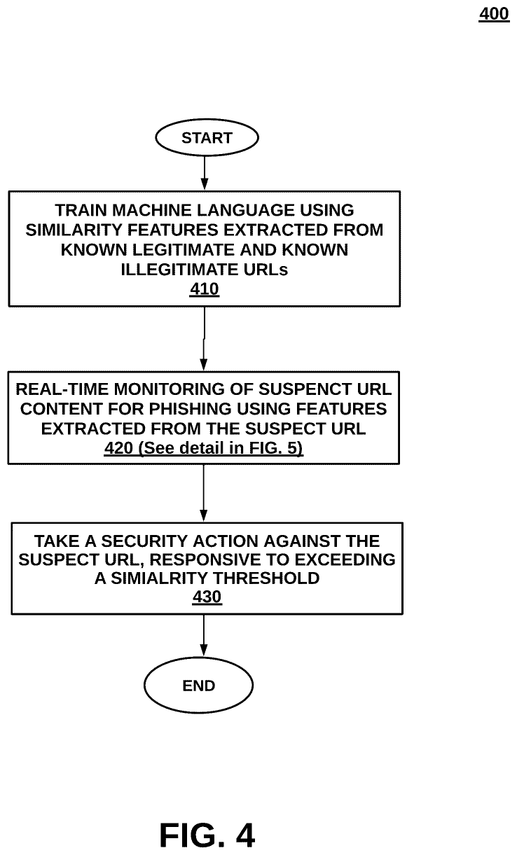

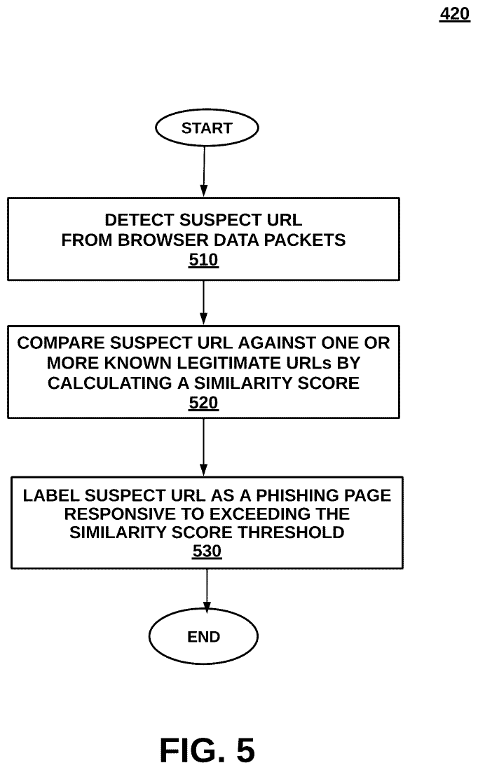

### II. Methods for Phishing Detection With Machine Learning (FIGS. 4-5)

FIG. 4 is a high-level flow diagram of a method 400 for detecting phishing attempts using machine learning of similarity features for web page comparisons, according to an embodiment. The method 400 can be implemented by, for example, system 100 of FIG. 1. The specific grouping of functionalities and order of steps are a mere example as many other variations of method 500 are possible, within the spirit of the present disclosure. Other variations are possible for different implementations.

At step 410, a machine language model is trained (and updated) using similarity features extracted from known legitimate web pages and known illegitimate web pages. The similarity features can include visual vector embeddings, text embeddings and DOM embeddings. The model is implemented at step 420, for real-time monitoring of suspect URL content for impersonation/phishing using similarity features extracted from the suspect URL, as detailed in FIG. 5. Based on the model analysis, at step 430, a security action can be taken against the suspect URL, according to a specific phishing policy and/or a general network security policy.

FIG. 5 is a more detailed flow diagram of step 420 of using the trained machine language model for real-time URL monitoring, according to an embodiment. The method 500 can be implemented by, for example, system 100 of FIG. 1. The specific grouping of functionalities and order of steps are a mere example as many other variations of method 500 are possible, within the spirit of the present disclosure. Other variations are possible for different implementations.

At step 510, a URL that is potentially malicious is detected. In one example, the URL is parsed from a HTTP request for web content. In another example, the URL content is captured from an HTTP response for the returned web content.

At step 520, the detected URL is compared against one or more known legitimate URLs (and/or known illegitimate URLs) by calculating a similarity score between the detected URL and the known legitimate domain with respect to similarity features. The similarity score comprises a combination of a visual similarity score, a text similarity score and a DOM structure similarity score, and the similarity threshold represents a tolerance of variations from minor changes between the detected URL versus the one or more legitimate domains. A DOM structure comprises a dynamic representation of the detected URL.

At step 530, the detected URL is labeled as a phishing URL if the similarity score exceeds a similarity threshold check. Otherwise, the detected URL is labeled as legitimate or unknown.

### III. Computing Device for Phishing Detection With Machine Learning (FIG. 6)

FIG. 6 is a block diagram illustrating a computing device 600 for use in the system 100 of FIG. 1, according to one embodiment. The computing device 600 is a non-limiting example device for implementing each of the components of the system 100, including phishing server 110, gateway device 120 and station 130. Additionally, the computing device 600 is merely an example implementation itself, since the system 100 can also be fully or partially implemented with laptop computers, tablet computers, smart cell phones, Internet access applications, and the like.

The computing device 600, of the present embodiment, includes a memory 610, a processor 620, a hard drive 630, and an I/O port 640. Each of the components is coupled for electronic communication via a bus 650. Communication can be digital and/or analog and use any suitable protocol.

The memory 610 further comprises network access applications 612 and an operating system 614. Network access applications can include 612 a web browser, a mobile access application, an access application that uses networking, a remote access application executing locally, a network protocol access application, a network management access application, a network routing access applications, or the like.

The operating system 614 can be one of the Microsoft Windows® family of operating systems (e.g., Windows 98, 98, Me, Windows NT, Windows 2000, Windows XP, Windows XP x84 Edition, Windows Vista, Windows CE, Windows Mobile, Windows 7, Windows 8 or Windows 10), Linux, HP-UX, UNIX, Sun OS, Solaris, Mac OS X-XV, Alpha OS, AIX, IRIX32, or IRIX84. Other operating systems may be used. Microsoft Windows is a trademark of Microsoft Corporation.

The processor 620 can be a network processor (e.g., optimized for IEEE 802.11), a general-purpose processor, an access application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the hard drive 630.

The storage device 630 can be any non-volatile type of storage such as a solid state, magnetic disc, EEPROM, Flash, or the like. The storage device 630 stores code and data for access applications.

The I/O port 640 further comprises a user interface 642 and a network interface 644. The user interface 642 can output to a display device and receive input from, for example, a keyboard. The network interface 644 connects to a medium such as Ethernet or Wi-Fi for data input and output. In one embodiment, the network interface 644 includes IEEE 802.11 antennae.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent access point with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The phrase network appliance generally refers to a specialized or dedicated device for use on a network in virtual or physical form. Some network appliances are implemented as general-purpose computers with appropriate software configured for the particular functions to be provided by the network appliance; others include custom hardware (e.g., one or more custom Application Specific Integrated Circuits (ASICs)). Examples of functionality that may be provided by a network appliance include, but is not limited to, layer 2/3 routing, content inspection, content filtering, firewall, traffic shaping, application control, Voice over Internet Protocol (VoIP) support, Virtual Private Networking (VPN), IP security (IPSec), Secure Sockets Layer (SSL), antivirus, intrusion detection, intrusion prevention, Web content filtering, spyware prevention and anti-spam. Examples of network appliances include, but are not limited to, network gateways and network security appliances (e.g., FORTIGATE family of network security appliances and FORTICARRIER family of consolidated security appliances), messaging security appliances (e.g., FORTIMAIL and FORTIPHISH families of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTI Wi-Fi family of wireless security gateways), FORIDDOS, wireless access point appliances (e.g., FORTIAP wireless access points), switches (e.g., FORTISWITCH family of switches) and IP-PBX phone system appliances (e.g., FORTIVOICE family of IP-PBX phone systems).

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical access applications. This description will enable others skilled in the art to best utilize and practice the invention in various embodiments and with various modifications as are suited to a particular use.

The scope of the invention is defined by the following claims.

I claim:

1. A computer-implemented method in a security device to detect phishing attempts using machine learning of similarity features for web page comparisons, the method comprising:
generating a legitimate web page database of known legitimate domains with similarity features, wherein the similarity features include visual vector embeddings, text embeddings and DOM embeddings;
detecting a URL that is potentially malicious, and comparing the detected URL against one or more known legitimate domains by calculating a similarity score between the detected URL and the known legitimate domain with respect to similarity features, against a similarity threshold, wherein the similarity score comprises a combination of a visual similarity score, a text similarity score and a Document Object Model (DOM) structure similarity score, and the similarity threshold represents a tolerance of variations from minor changes between the detected URL versus the one or more legitimate web pages, wherein a DOM structure comprises a dynamic representation of the detected URL; and
responsive to detecting a malicious URL based on the similarity score of the detected URL exceeding the similarity threshold, taking a security action against the detected URL as a phishing attempt according to a network security policy.

2. The method of claim 1, wherein the visual similarity score is based on a vector-based comparison comprising at least one of cosine similarity and k-Nearest Neighbor (k-NN) search.

3. The method of claim 1, wherein the text similarity score is based on a vector-based comparison comprising a semantic analysis.

4. The method of claim 1, wherein the DOM based similarity score is based on a vector-based comparison comprising a complete structure and hierarchy of the detected URL, including both visible elements and hidden elements of the detected URL.

5. The method of claim 1, further comprising:
compressing visual and textual elements of known illegitimate pages to a fingerprints for storage; and
calculating a fuzzy similarity score based on a degree of content overlap between a fingerprint of the detected URL and a fingerprint of known illegitimate pages.

6. The method of claim 1, wherein the similarity score comprises configurable weight parameters that define the relative importance of each similarity type.

7. The method of claim 1, wherein the security action comprises at least one of quarantining the detected URL and blocking the detected URL, according to the network security policy.

8. The method of claim 1, wherein the security action depends on the amount of variation shown in the similarity score differences of the detected URL and the one or more legitimate domains, wherein higher variations result in harsher security actions.

9. The method of claim 1, wherein the security device is embedded within an Internet browser, wherein the DOM structure is generated from an instance of the Interact browser for interacting with key page elements of the detected URL to determine behaviors.

10. A non-transitory computer-readable medium in a network security device, on a data communication network, for detect phishing attempts using machine learning of similarity features for web page comparisons, the method comprising:
tracking
generating a legitimate web page database of known legitimate domains with similarity features, wherein the similarity features include visual vector embeddings, text embeddings and DOM embeddings;
detecting a URL that is potentially malicious, and comparing the detected URL against one or more known legitimate domains by calculating a similarity score between the detected URL and the known legitimate domain with respect to similarity features, against a similarity threshold, wherein the similarity score comprises a combination of a visual similarity score, a text similarity score and a Document Object Model (DOM) structure similarity score, and the similarity threshold represents a tolerance of variations from minor changes between the detected URL versus the one or more legitimate web pages, wherein a DOM structure comprises a dynamic representation of the detected URL; and
responsive to detecting a malicious URL based on the similarity score of the detected URL exceeding the similarity threshold, taking a security action against the detected URL as a phishing attempt according to a network security policy.

11. A network security device, on a data communication network, for, on a data communication network, for detect phishing attempts using machine learning of similarity features for web page comparisons, the network security device comprising:
a processor;
a network interface communicatively coupled to the processor and to a data communication network; and
a memory, communicatively coupled to the processor and storing:
a URL training module to generate a legitimate web page database of known legitimate domains with similarity features, wherein the similarity features include visual vector embeddings, text embeddings and DOM embeddings;
a URL monitoring module to detect a URL that is potentially malicious, and comparing the detected URL against one or more known legitimate domains by calculating a similarity score between the detected URL and the known legitimate domain with respect to similarity features, against a similarity threshold, wherein the similarity score comprises a combination of a visual similarity score, a text similarity score and a Document Object Model (DOM) structure similarity score, and the similarity threshold represents a tolerance of variations from minor changes between the detected URL versus the one or more legitimate web pages, wherein a DOM structure comprises a dynamic representation of the detected URL; and
a URL security action module to, responsive to detecting a malicious URL based on the similarity score of the detected URL exceeding the similarity threshold, take a security action against the detected URL as a phishing attempt according to a network security policy.
